(19) United States
(12) Patent Application Publication
(10) Pub. No.: US 2007/0150530 A1
(43) Pub. Date: Jun. 28, 2007

(54) Resisting cache timing based attacks

(75) Inventors: Michael Neve de Mevergnies, Hillsboro, OR (US); Jean-Pierre Seifert, Hillsboro, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/302,579

(22) Filed: Dec. 13, 2005

(51) Int. Cl. G06J 1/00

(52) U.S. Cl. 708/7

(57) ABSTRACT

Executing a program on a processor based system, the program including an implementation of an algorithm including one or more modular multiplication operations and one or more modular squaring operations, such that the program performs the execution of each of the one or more modular multiplication operations in a first thread of execution, and performs the execution of each of the one or more modular squaring operations in a second thread of execution distinct from the first thread.

### BACKGROUND

The Rivest, Shamir and Adelman (RSA) algorithm is a well known technique for encrypting plaintext and decrypting ciphertext based on a public and private key pair. A basic implementation of RSA may use a sequential program for exponentiation by squaring and multiplying. This implementation performs a sequence of modular multiplications and modular squaring operations for encryption and decryption. This sequence depends on the bit sequence in the private key, and thus an observer able to determine the sequence of modular multiplications and squaring operations used by an process performing an RSA operation may be able to determine the bit sequence in a private key used by the process.

One known technique to observe this sequence uses the fact that hyperthreaded or multiple core processors may have a cache that is shared between threads. In such systems an observer thread that executes overlapped in time with a concurrently executing user or system thread may obtain information about the user or system thread by observing the timing of its own memory accesses. This is because the time taken for a memory access depends on the current contents of the processor cache that is shared between the threads. As a result it may be possible for an observer thread to deduce an RSA private key in use by a thread performing an RSA operation (RSA thread) as follows. The contents of the cache when the RSA thread is performing a modular multiply differ from the contents when the RSA thread is performing other operations. The observer thread may exploit this difference by timing its own accesses to memory through the cache and noting the timing differences associated with the changes in cache content caused by the current execution state of the RSA thread, and thus deducing the sequence of bits in the private key used by the RSA thread. Thus the shared processor cache allows leakage of information about the RSA computation between the RSA thread and the observer thread despite there being no overt access to any of the data or code of the RSA thread available to the observer thread. Thus a malicious thread such as a worm, virus, spyware, etc. may use this technique to compromise a private RSA key on a computer system that has a hyperthreaded or multi-core processor and on which concurrent threads execute using a shared cache.

This and other cache timing based techniques to attack encryption schemes are more fully described, for example, in D. J. Bernstein, “Cache-timing attacks on AES”, http://cr.yp.to/papers.html#cachetiming, 37 pages, 2005; Y. Tsunoo, T. Saito, T. Suzaki, M. Shigeri, H. Miyauchi, “Cryptanalysis of DES implemented on computers with cache”, Proc. of CHES 2003, Springer LNCS, pp. 62-76, 2003; D. A. Osvik, A. Shamir, E. Tromer, “Other People's Cache: Hyper Attacks on HyperThreaded Processors”, presentation available from http://www.wisdom.weizmann.ac.il/˜tromer; and C. Percifal, “CACHE MISSING FOR FUN AND PROFIT”, available from Colin Percifal through email cperciva@freebsd.org.

### BRIEF DESCRIPTION OF THE DRAWINGS

FIG. 1 depicts a processor based system in one embodiment.

FIG. 2 depicts a basic implementation of a portion of an RSA computation.

FIG. 3 depicts at a high level a countermeasure against cache timing based attacks on RSA computations in one embodiment.

FIG. 4 is a flow diagram depicting processing in a Montgomery Ladder scheme implementing a portion of an RSA computation in one embodiment.

### DETAILED DESCRIPTION

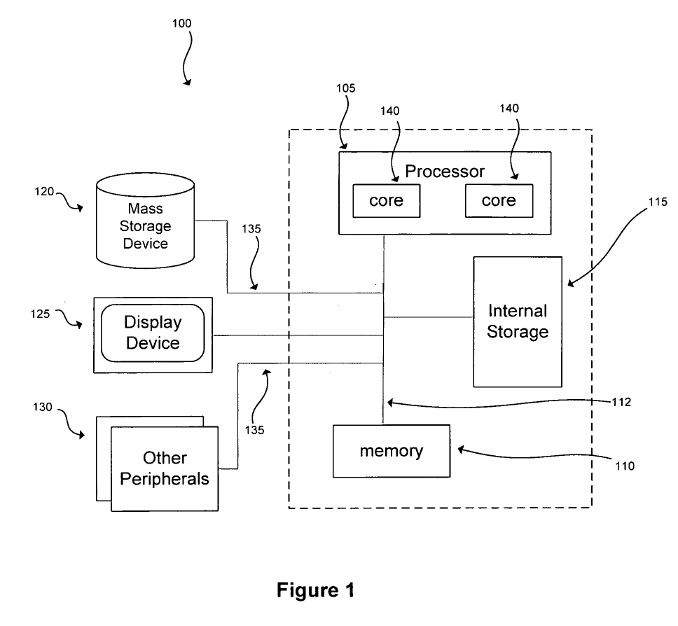

A processor based system in an embodiment is depicted in FIG. 1. The system 100 consists of a processor 105 with two cores 140. The processor is connected to internal storage such as a disk drive system 115 and a memory 110 by one or more buses in an internal bus system 112. The internal bus system is also interconnected to an external bus or buses 135 that may connect to peripherals such as an external display device 125, external mass storage devices such as a CDROM or DVD-RW device 120 and other peripherals, 130.

The processor 105 of system 100 is capable of allowing the parallel execution of multiple executing processes or threads. In this embodiment, a thread may execute on each core of the processor, thus allowing the parallel execution of two threads at one time. Typically, processor 105 will include one or more caches that are accessible by both threads executing on the processor.

Many different embodiments of a processor based system like the one depicted in FIG. 1 are possible. In some embodiments there may be more or less than two cores present in processor 105. Specifically, the processor in some embodiments may be a single-core hyperthreaded processor such as an Intel® Pentium® 4 Processor with HT Technology that allows the execution of concurrent pairs of threads on a single-core processor, and allows the threads to share the processor cache. In yet other embodiments, a multi-processor system may be used with a cache system that allows threads executing on each of the processors concurrent shared access to the cache. The specific organization of the memory, storage, and peripherals in some embodiments may differ. In some embodiments, certain peripherals may be omitted, or the system may include other interfaces not shown in the Figure such as network connectors, audio i/o and many others. Many other embodiments may be employed as would be appreciated by the artisan.

As is known, a typical computation of RSA decryption may involve the computation of
m=c^{d} mod n
where m is the plaintext, c is the ciphertext, d is the private key, and n is the public exponent. To compute the value c^{d}, a typical implementation uses a fast exponentiation algorithm.

A typical known implementation of a fast exponentiation algorithm is provided below in Table 1, in pseudocode.

TABLE 1

| # | compute c^{d} |
|---|---|
| 1 | power(c,d) |

| | |
|---|---|
| 2 | result = 1 |
| 3 | while (d != 0) |

| | |
|---|---|
| 4 | # if d is odd, multiply result withc. decrement d by 1 |
| 5 | if (d mod 2 == 1) |

| | |
|---|---|
| 6 | result = result * c |
| 7 | d = d−1 |

| | |
|---|---|
| 8 | end |
| 9 | # last iteration: no need to computec = one more power of 2 |
| 10 | if (d > 0) then |

| | |
|---|---|
| 11 | c = c*c |
| 12 | d = d/2 |

| | |
|---|---|
| 13 | end |

| | |
|---|---|
| 14 | end |
| 15 | return result |

| | |
|---|---|
| 16 | end |

As may be observed from the Table, the algorithm performs a multiplication result*c at line 6 in the while-loop at lines 3-14, for each odd bit of the exponent (secret key) d. This behavior of the exponentiation component of an RSA decryption may be observed by a concurrently executing observer thread in a hyperthreaded or multicore system using a cache timing approach to distinguish the iterations of the loop with multiplications, from the ones without multiplications, and thus potentially to deduce the bit sequence of the secret key.

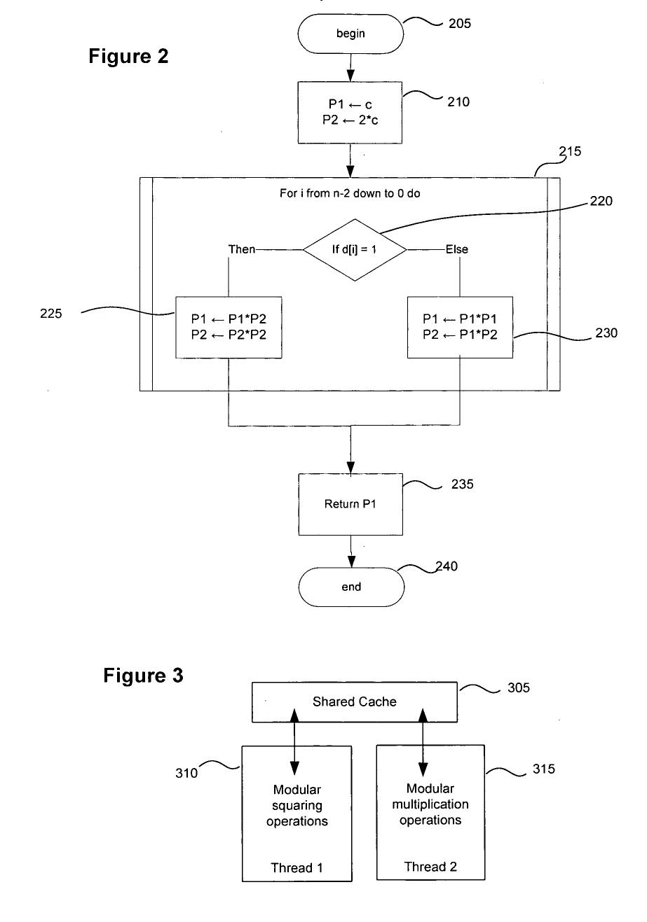

An alternative implementation of exponentiation known as the Montgomery Ladder algorithm may be used to overcome this problem. This algorithm is described in the flowchart in FIG. 2. The algorithm, like that in Table 1, computes the value of c^{d}. but uses a different method without the asymmetry of the previously discussed algorithm.

As seen in the figure, on entry 205, the algorithm creates two temporary variables P1 and P2 initialized to the value of c and 2*c respectively, 210. It then iterates in a loop 215 through the bits of the exponent d, and for each bit of d, the algorithm performs the same pair of operations, a squaring and a multiplication at 225 and 230. The only difference is in the choice of variables between the two branches at the if 220, but the operations are the same: in each case, a squaring and multiplication are performed. The computed result is returned at 235 and the algorithm terminates, 240. Thus the asymmetry of the known algorithm of Table 1 can be eliminated by the algorithm of FIG. 2.

It is possible to improve the resistance of this algorithm to cache timing based attacks in a hyperthreaded or multicore processor based system in one embodiment by adapting it into a parallel form as shown at a high level in FIG. 3. As shown in the figure, the algorithm is executed in two threads, executing concurrently, and furthermore the threads perform the same computation for each iteration through the bits of the exponent. Thus, a first thread 310 performs only modular squaring operations; and the second 315 performs only modular multiplication operations. Their accesses to the shared cache 305 are then the same for each iteration and therefore an observer process may not be able to deduce the value of a given bit of the exponent is because the computation type (multiplication in one thread and squaring in the other) is identical for all bits independent of the value of any one bit. Additionally, in some hyperthreaded processors, the simultaneous execution of more than two threads at once is not available, so in such cases the parallel RSA process occupies both the thread slots available and reduces opportunity for the concurrent execution of a malicious observer thread.

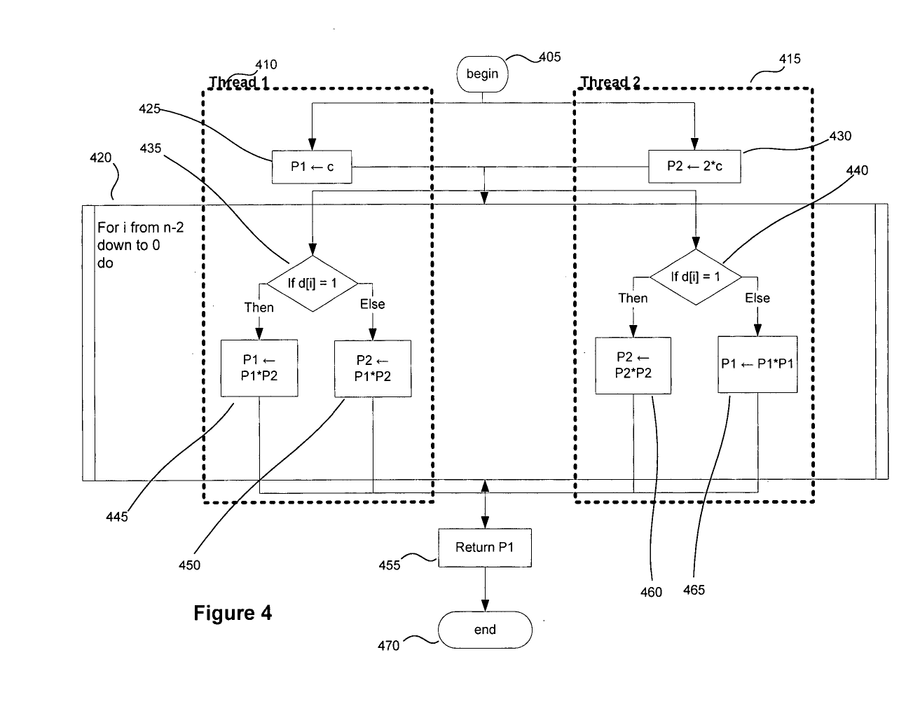

The algorithm of FIG. 2 as adapted for hyperthreading in accordance with the scheme outlined in FIG. 3 is shown in the embodiment depicted in FIG. 4 which depicts a parallel version of the Montgomery Ladder algorithm. After initialization 405, the algorithm in this embodiment divides the processing into two threads 410 and 415. One thread initializes a local variable P1 to c while the other symmetrically initializes a local variable P2 to 2*c at 425 and 430 respectively. Each thread then enters a loop 420 that iterates through the bits of exponent d. In the first thread, regardless of the value of the current bit d[i] at 435, the thread computes a product P1*P2 at 445 and 450. In the second thread, regardless of the value of the current bit d[i] at 440, the thread computes either the square of P2 at 460 or the square of P1 at 465. Thus, any attempt to observe the threads, even if feasible, would be unlikely to detect differences between iterations in either thread based on the value of the current bit of the exponent d and so the value of d is less likely to be detectable by cache timing based attacks on this implementation. On completion of the Montgomery ladder, the process returns the value of P1, 455, and exits at 470.

It should be noted that the implementation of one embodiment described with reference to FIG. 3 and FIG. 4 may be varied in other embodiments. For example, the specific variable names used in the descriptions may differ in descriptions of other embodiments. In some embodiments different control structures may be used, as is known in the art, to replace the for loop depicted in FIG. 4 with another type of loop such as a while or other loop. The loop and if-then-else structures may be substituted by lower level transfers of control such as jumps or gotos. The programs implementing an embodiment may be written in one a very large number of available programming languages or in assembly language for any of a large number of instruction sets. The actual mechanism by which the threads shown in FIG. 4 are defined, initiated and terminated may vary from one processor based system to the next. In some systems, threads may be termed “processes,” and other similar terms may be used. While the above embodiments are described with reference to Intel processors, many processor architectures may support multiple concurrent threads or processes with a shared cache, and the above implementation may be embodied in an appropriate form on such processor architectures. As indicated previously, embodiments may be implemented on multi-processor machines as well as on multi-core or hyperthreaded machines. Many other variations are possible as would be appreciated by the artisan.

In the preceding description, for purposes of explanation, numerous specific details are set forth in order to provide a thorough understanding of the described embodiments, however, one skilled in the art will appreciate that many other embodiments may be practiced without these specific details.

Some portions of the detailed description above are presented in terms of algorithms and symbolic representations of operations on data bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a program product, wherein the program may be transferred from a remote data source to a requesting device by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below.

What is claimed is:

1. A method comprising:
Executing a program on a processor based system, the program comprising an implementation of an algorithm comprising one or more modular multiplication operations and one or more modular squaring operations, such that the program performs the execution of each of the one or more modular multiplication operations in a first thread of execution; and
performs the execution of each of the one or more modular squaring operations in a second thread of execution distinct from the first thread.

2. The method of claim 1 wherein the algorithm further comprises an algorithm to compute for integers c, d and n, the value c^{d} mod n.

3. The method of claim 2 wherein the algorithm further comprises a Montgomery's Ladder algorithm to compute c^{d} mod n.

4. The method of claim 3 wherein both the first thread and the second thread execute on a hyperthreaded processor core.

5. The method of claim 3 wherein the first thread executes on a first core of a multicore system and the second thread executes on a second core of the multicore system.

6. The method of claim 3 wherein the value c^{d} mod n is used in at least one of
an RSA encryption process; and
an RSA decryption process.

7. The method of claim 3 wherein an operating system schedules
the execution of each of the one or more modular multiplication operations in the first thread of execution; and
the execution of each of the one or more modular squaring operations in the second thread of execution.

8. The method of claim 3 wherein the program schedules
the execution of each of the one or more modular multiplication operations in the first thread of execution; and
the execution of each of the one or more modular squaring operations in the second thread of execution.

9. A machine readable medium having stored thereon data that when accessed by a machine causes the machine to perform a method, the method comprising:
Executing a program on a processor based system, that comprises an implementation an algorithm comprising one or more modular multiplication operations and one or more modular squaring operations such that the program
performs the execution of each of the one or more modular multiplication operations in a first thread of execution; and
performs the execution of each of the one or more modular squaring operations in a second thread of execution distinct from the first thread.

10. The machine readable medium of claim 9 wherein the algorithm further comprises an algorithm to compute for integers c, d and n, the value c^{d} mod n.

11. The machine readable medium of claim 10 wherein the algorithm further comprises a Montgomery's Ladder algorithm to compute c^{d} mod n.

12. The machine readable medium of claim 11 wherein both the first thread and the second thread execute on a hyperthreaded processor core.

13. The machine readable medium of claim 11 wherein the first thread executes on a first core of a multicore system and the second thread executes on a second core of the multicore system.

14. The machine readable medium of claim 11 wherein the value c^{d} mod n is used in at least one of
an RSA encryption process; and
an RSA decryption process.

15. The machine readable medium of claim 11 wherein an operating system schedules
the execution of each of the one or more modular multiplication operations in the first thread of execution; and
the execution of each of the one or more modular squaring operations in the second thread of execution.

16. The machine readable medium of claim 11 wherein the program schedules
the execution of each of the one or more modular multiplication operations in the first thread of execution; and
the execution of each of the one or more modular squaring operations in the second thread of execution.

17. A processor based system comprising:
a processor to execute a program;
a memory in which the program is loaded;
and a storage for storing the program;
the program further comprising an implementation of an algorithm comprising one or more modular multiplication operations and one or more modular squaring operations, such that the program
performs the execution of each of the one or more modular multiplication operations in a first thread of execution; and
performs the execution of each of the one or more modular modular squaring operations in a second thread of execution distinct from the first thread.

18. The system of claim 17 wherein the algorithm further comprises an algorithm to compute for integers c, d and n, the value c^{d} mod n.

19. The system of claim 18 wherein the algorithm further comprises a Montgomery's Ladder algorithm to compute c^{d} mod n.

20. The system of claim 19 wherein both the first thread and the second thread execute on a hyperthreaded processor core.

21. The system of claim 19 wherein the first thread executes on a first core of a multicore system and the second thread executes on a second core of the multicore system.
